(19) United States
(12) Patent Application Publication
(10) Pub. No.: US 2006/0126954 A1
(43) Pub. Date: Jun. 15, 2006

(54) Image compression apparatus and method capable of varying quantization parameter according to image complexity

(75) Inventor: Tae Eung Kim, Gyeonggi-do (KR)

Correspondence Address: DARBY & DARBY P.C., P. O. BOX 5257, NEW YORK, NY, 10150-5257, US

(73) Assignee: Samsung Electro-Mechanics Co., Ltd., Kyunggi-do (KR)

(21) Appl. No.: 11/165,766

(22) Filed: Jun. 23, 2005

(30) Foreign Application Priority Data
Dec. 9, 2004 (KR) 10-2004-0103830

(51) Int. Cl. G06K 9/36; G06K 9/38

(52) U.S. Cl. 382/239; 382/251

(57) ABSTRACT

Disclosed herein is an image compression apparatus and method for a mobile communication terminal. The image compression apparatus includes an image sensor unit, an Image Signal Processor (ISP), an auto focus Digital Signal Processor (DSP), and a compression module. The image sensor unit converts an optical signal into an electrical signal. The ISP unit receives the electrical signal from the image sensor unit and outputs digitized image data. The auto focus DSP receives the image data from the ISP, extracts edge components from the image data, calculates a focus value by integrating the edge component values of a window set region, and calculates a maximal focus value while driving the focus lens of a lens unit. The compression module receives the maximal focus value from the auto focus DSP, and performs image compression while quantizing the image data, which are input from the ISP unit, using a quantization parameter determined according to the received maximal focus value.

### INCORPORATION BY REFERENCE

The present application claims priority under 35 U.S.C. §119 to Korean Patent Application No. 10-2004-0103830 filed on Dec. 9, 2004. The content of the application is incorporated herein by reference in its entirety.

### BACKGROUND OF THE INVENTION

1. Field of the Invention

The present invention relates generally to the compression module of a mobile communication terminal and a method of controlling the compression module and, more particularly, to a compression module that allows the compression ratio of the compression module, which is provided in a mobile phone, a smart phone or a personal digital assistant, to vary, and a method of controlling the compression module.

2. Description of the Related Art

Currently, mobile communication terminals provide a variety of additional functions besides an original function of allowing users to make phone calls, and thus have become necessities that increase users' convenience.

Composite devices that are implemented by combining one or more of a plurality of separately provided electronic devices with a mobile communication terminal (especially, mobile phone), for example, a radio phone, which is implemented by combining a mobile phone with a radio to provide both telephone and radio listening functions, have become necessities that increase users' convenience.

Composite mobile phones that are implemented by combining one or more of a plurality of separately provided electronic devices with a mobile communication terminal, such as a radio phone implemented by combining a radio with a mobile phone to provide both telephone and radio listening functions, a Television (TV) phone implemented by combining a mobile phone with a TV to provide both telephone and TV watching functions, an Internet phone that provides both telephone and Internet functions, and a camera phone implemented by combining a mobile phone with a camera to provide both telephone and camera functions, have been developed, so that users can conveniently use the additional functions that are provided in mobile phones, which are convenient to carry. Further, efforts are concentrated on the development of next generation mobile phones that are capable of maximizing efficiency and users' convenience.

Of the above-described composite mobile phones that are convenient to use and carry, a so-called “camera phone,” in which a mobile phone is combined with a camera, provides functions of taking a photograph of a subject, storing the photograph, reproducing the photograph, using the photograph as a background screen, and transmitting the photograph to another location via electronic-mail (e-mail) or telephone.

FIG. 1 is a block diagram showing the construction of a conventional camera phone in which an image processor is provided in a cover body 213. The main body 220 includes a wireless circuit unit 130 for communicating with a base station, an audio circuit unit 140 for performing voice communication, a keypad 120 for receiving key inputs, memory 110 for storing various types of programs and data, and a control unit 100 for controlling the above-described operations.

In the case of a Code Division Multiple Access (CDMA) mobile phone, a one-chip type modem chip, called a Mobile Station Modem (MSM), is commonly used as the control unit 100. The control unit 100 contains a Phase Locked Loop (PLL) for wireless communication, a CDMA processor, a vocoder, a keypad interface, a serial interface and a processor core.

The main body 220 further includes a microphone 50 for converting a user's voice into an electrical signal and an antenna for transmitting and receiving a radio wave.

A Liquid Crystal Display (LCD) module 30, which is a display device for displaying characters and images, is mounted on the cover body 213.

The LCD module 30 is provided in the form of a module, so that it includes both an LDC panel and an LCD driver for driving the LCD panel. Furthermore, an LCD controller 150 for performing control operations to display characters or images on the LCD panel is provided on the LCD module 30 or a flexible circuit.

Furthermore, a speaker 26 for outputting a voice that is received from the other party during wireless communication is provided on the cover body 213. Although not shown in the FIG. 1, the cover body 213 generally includes a loudspeaker or piezo device for informing a user of the reception of a telephone call, and a vibration motor for informing a user of the reception of a telephone call in a manner mode.

Furthermore, a camera module 27 and a camera interface 170 are placed in the cover body 213. In the case of a mobile phone capable of receiving a moving image or performing image communication using the camera module 27, an image processor 160 for processing moving images is provided in the main body 220.

For example, TC35273XB, that is, a Moving Picture Experts Group (MPEG) 4 processor, is used as the image processor 160. The image processor 160 exclusively decodes and/or encodes moving images that cannot be processed by a main processor alone, thus allowing moving images to be processed in mobile phones.

The image processor 160 is generally provided with a plurality of ports that are used for connection with an LCD module, a camera, a microphone and a speaker.

As described above, the conventional folding mobile phone is advantageous in that a large-sized screen can be provided despite the small size of the mobile phone. However, the conventional folding mobile phone requires a means for electrically connecting the cover body to the main body. To improve the ease of assembly, reduce noise and enhance tolerance to noise, it is desirable to limit the number of connection lines.

Furthermore, in order to conform with the trends of a decreasing life cycle of mobile phones and the advent of various display devices, a mobile phone that has a structure that can cope with various types of display devices and multimedia functions without the modification of a main board or with only simple modification of the main board is required.

FIG. 2 is a block diagram showing the construction of a conventional camera phone in which an image processor 160 based on an improved technology is provided in a cover body 213. In this case, a separate board for the image processor 160 may be provided in the cover body 213, but it is preferred that the image processor 160 be placed in an LCD module or on a flexible circuit.

When it is desired to display a moving or still image on an LCD 30, a controller 100 reads compressed image data from memory 110 and transmits the data to the image processor 160.

Then, the image processor 160 decompresses the compressed image data and transmits the decompressed image data to the LCD controller 150. The LCD controller 150 causes a desired image to be displayed on an LCD panel by controlling the LCD module 30 according to the decompressed image data.

As described above, since compressed data are transmitted between the control unit 100 and the image processor 160, that is, between the cover body and the main body, the amount of data that must be transmitted between the cover body and the main body is reduced by a compression ratio.

Meanwhile, in the image processor, image compression is performed after the quantization parameter of the quantizer of a compression module is adjusted. When the compression ratio is lowered to maintain a fine image, the quantization parameter is adjusted to reduce the size of a quantization step. In contrast, when the compression ratio is increased to reduce the amount of data at the expense of low image quality, the quantization parameter is adjusted to increase the size of the quantization step.

However, the method has the following problem. For example, since the size of the quantization step is consistently applied to both simple and complex images using the same quantization parameter when fine images are desired, the images are compressed without consideration of weighted values that depend on the degree of image complexity. Accordingly, although a simple image can be slightly compressed and its fineness can be mostly retained using a low compression ratio, the low compression ratio is not efficiently applied to the simple image, so that memory loss occurs. In contrast, since additional data cannot be allocated to the complex image, a problem occurs in that the amount of data is not appropriately adjusted.

As a result, when the image processor of the camera module acquires information about the degree of image complexity and compresses a complex image based on the acquired information, it is necessary to allow additional data to be allocated to the complex image.

A method of solving the problem of the conventional art is disclosed in Korean Pat Appl. No. 2003-0001109 entitled “Method of controlling digital camera for performing adaptive recompression,” which does not pertain to technology for a camera module that is mounted on a mobile communication terminal, but pertains to technology for a digital camera.

The “Method of controlling digital camera for performing adaptive recompression” discloses a method in which, when the available amount of memory in a memory card is insufficient to store new photographs while a user takes photographs outdoors, the user recompresses some of the image files already stored in the memory card using a higher compression ratio, rather than selecting and deleting some of the image files, thus being capable of reducing the size of the image files.

The disclosed method is a digital camera control method, in which image files are compressed using one of at least first to third compression ratios selected by a user and are stored in the memory card, and the method includes a checking step and first and second compression steps.

At the checking step, when the available amount of memory in the memory card becomes insufficient, whether image files that have been compressed at the first compression ratio, that is, a low compression ratio, or the second compression ratio, that is, an intermediate compression ratio, exist is determined.

At the first step, when image files that have been compressed at the first compression ratio exist, one of the image files that has been compressed at the first compression ratio is compressed at the second compression ratio according to the user's selection and is then stored in the memory card.

At the second compression step, if no image file that has been compressed at the first compression ratio exists and image files that have been compressed at the second compression ratio exist, one of the image files that has been compressed at the second compression ratio, is selected by the user and compressed at the third compression ratio, that is, a compression ratio higher than the second compression ratio, and then stored in the memory card.

In the prior art as described above, the available amount of memory in the memory card increases according to the user's selection. Accordingly, when the available amount of memory in a memory card becomes insufficient to store new photograph while a user takes photographs outdoors, it is not necessary for the user to select and delete previously stored image files. In this case, compression ratios that have been set by the user for respective image files, can be maximally maintained.

However, it is not easy to apply the prior art to mobile communication terminals. Although applied to mobile communication terminals, the prior art is used only in the case where the available amount of memory in the memory card becomes insufficient. In addition, the prior art is problematic in that it does not consider the degree of complexity of each image.

### SUMMARY OF THE INVENTION

Accordingly, the present invention has been made keeping in mind the above problems occurring in the prior art, and an object of the present invention is to provide an image compression apparatus and method, in which information about the degree of image complexity is acquired by the image processing unit of a camera module and much data are allocated when a complex image is compressed.

In order to accomplish the above object, the present invention provides an image compression apparatus including an image sensor unit for converting an optical signal into an electrical signal; an Image Signal Processor (ISP) unit for receiving the electrical signal from the image sensor unit and outputting digitized image data; an auto focus Digital Signal Processor (DSP) for receiving the image data from the ISP, extracting edge components from the image data, calculating a focus value by integrating the edge component values of a window set region, and calculating a maximal focus value while driving the focus lens of a lens unit; and a compression module for receiving the maximal focus value from the auto focus DSP, and performing image compression while quantizing the image data, which are input from the ISP unit, using a quantization parameter determined according to the received maximal focus value.

In addition, the present invention provides an image compression method including the step of a combined image sensor and ISP unit converting an optical signal into an electrical signal and then outputting digitized image data; the step of an auto focus DSP receiving the image data from the ISP unit, extracting edge components, and calculating focus values by integrating the edge component values of a window set region; the step of the auto focus DSP calculating a maximal focus value while driving the focus lens of a lens unit; and the step of a compression module receiving the maximal focus value from the auto focus DSP, and performing image compression while quantizing the image data, which is input from the ISP, using a quantization parameter determined according to the received maximal focus value.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram showing the construction of a conventional camera phone in which an image processor is provided in a cover body;

FIG. 2 is a block diagram showing the construction of a conventional camera phone in which an image processor based on an improved technology is provided in a cover body;

FIG. 3 is a block diagram showing the construction of an image compression apparatus, which has a variable quantization size depending on the degree of image complexity, according to an embodiment of the present invention;

FIG. 4A is a block diagram showing the construction of the auto focus digital signal processor of FIG. 3;

FIG. 4B is a block diagram showing the internal construction of the optical detection module of FIG. 3;

FIG. 5 is a block diagram showing the internal construction of the compression module of FIG. 3;

FIG. 6A is a graph showing focus values according to lens movement distances;

FIG. 6B is a view illustrating the calculation values of the image formatting unit of FIG. 5;

FIG. 6C is a view showing a blocked image signal that is input to the frequency conversion unit of FIG. 5;

FIG. 6D is a view showing the distribution of discrete cosine transform coefficients that are output from the frequency conversion unit of FIG. 5;

FIG. 6E is a view showing the output values of the quantizer of FIG. 5; and

FIG. 7 is a flowchart illustrating an image compression method in accordance with an embodiment of the present invention.

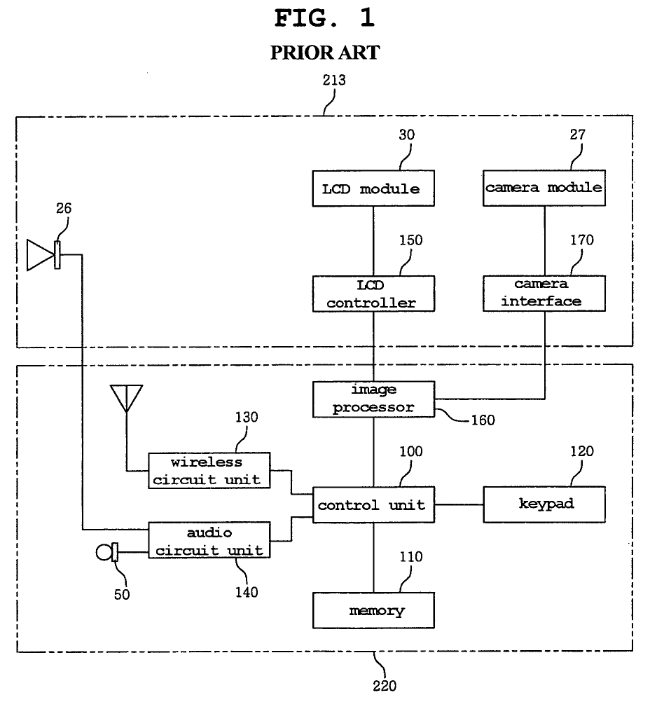

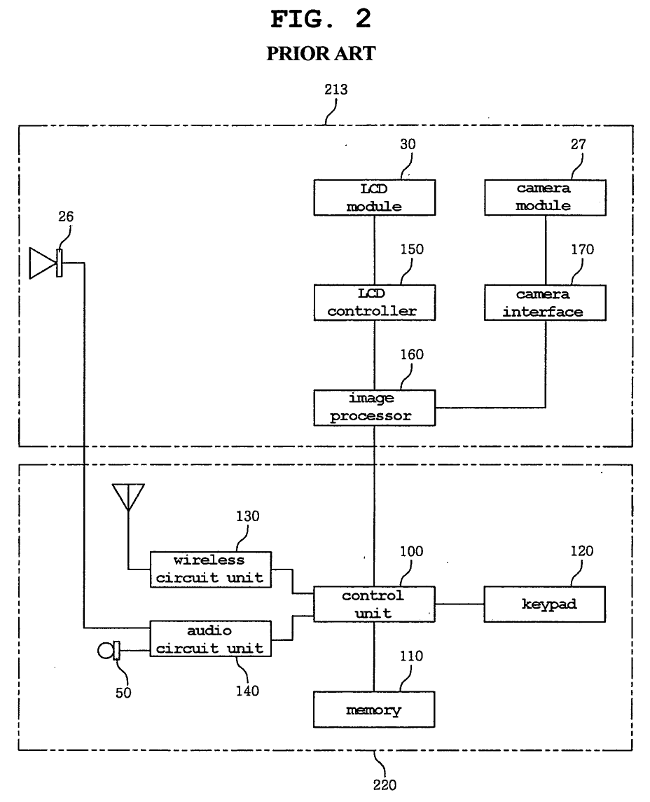

### DESCRIPTION OF THE PREFERRED EMBODIMENTS

An embodiment of the present invention is described in detail with reference to the accompanying drawings below.

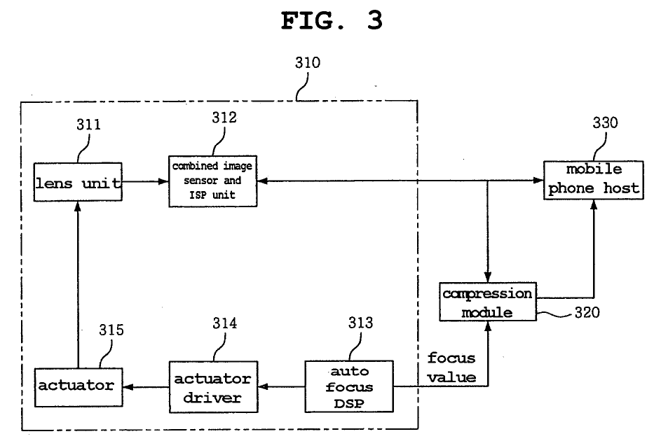

FIG. 3 is a block diagram showing the construction of an image compression apparatus according to an embodiment of the present invention. The image compression apparatus includes a camera module 310 for extracting a focus value and a compression module 320 for compressing an image by setting a variable quantization parameter according to the focus value extracted by the camera module 310 and then performing quantization.

The camera module 310 includes a lens unit 311, a combined image sensor and Image Signal Processor (ISP) unit 312, an auto focus Digital Signal Processor (DSP) 313, an actuator driver 314 and an actuator 315. Although in this case, the combined image sensor and ISP unit 312 is formed in a single body, the combined image sensor and image signal processor 312 may be separated into an image sensor and an image signal processor.

The lens unit 311 includes a zoom lens and a focus lens. The zoom lens is a lens for magnifying an image, and the focus lens is a lens for focusing an image.

The combined image sensor and ISP unit 312 employs a Charge Coupled Device (CCD) image sensor or a Complementary Metal Oxide Semiconductor (CMOS) image sensor for converting an optical signal into an electrical signal. An ISP improves image quality by converting image data to suit human visual capability, and outputs image data having improved image quality.

The CCD image sensor is formed by arranging a plurality of ultra small size metallic electrodes on a silicon wafer. The CCD image sensor is composed of a plurality of photodiodes, and converts an optical signal into an electrical signal when the optical signal is applied to the plurality of photodiodes.

Since the CCD image sensor transmits charges, generated in photodiodes, which correspond to pixels, to an amplifier through vertical and horizontal transfer CCDs using a high potential difference, it is characterized in that its power consumption is high, but it is robust against noise and performs uniform amplification.

In contrast, the CMOS image sensor is formed by arranging photodiodes and amplifiers for respective pixels. The CMOS image sensor has low power consumption and can be manufactured to have a small size, but is disadvantageous in that its image quality is low.

The kinds of CCD and CMOS image sensors vary, and their ISP interfaces and characteristics are different according to manufacturing company. Accordingly, an image signal processor is designed and manufactured for a specific sensor.

The image signal processor passes through image processing such as color filter array interpolation, color matrix processing, color correction and color enhancement.

In this case, a signal that is used as the synchronization signal of each image frame is composed of a vertical synchronization signal Vsync indicating the start of an image frame, a horizontal synchronization signal Hsync indicating the active state of an image in each line within an image frame, and a pixel clock signal pixel_clock indicating the synchronization of pixel data. Pixel data with respect to an actual image are formed in the form of pixel_data.

Furthermore, the combined image sensor and ISP unit 312 converts image-processed data into a CCIR656 or CCIR601 format (YUV space), receives a master clock signal from a mobile phone host 330, and then outputs image data Y/Cb/Cr or R/G/B to the mobile phone host 330 along with a vertical synchronization signal Vsync, a horizontal synchronization signal Hsync and Pixel_Clock.

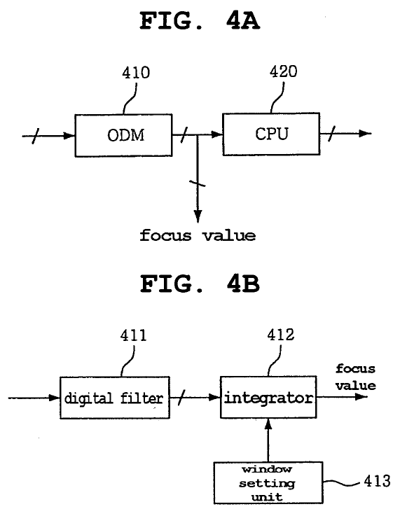

The auto focus DSP 313, as shown in FIG. 4A, is composed of an Optical Detection Module (ODM) 410 and a Central Processing Unit (CPU) 420 for performing an auto focus algorithm based on the resulting value of the ODM 410.

In this case, the ODM 410, as shown in FIG. 4B, is composed of a high band-pass digital filter 411, an integrator 412 and a window setting unit 413.

The auto focus DSP 313 receives the Y signal of image data that are transmitted from the combined image sensor and ISP unit 312 and passes it through the digital filter 411, thus extracting only an edge component from an image.

In this case, with respect to the window set region of the image, the integrator 412 receives the start and end positions of a window from the window setting unit 413 and integrates the output values of the digital filter 411 with respect to an image inside the window. A focus value obtained by the integration is used as reference data to adjust the focus in the camera module.

Generally, for a still image, the focus is adjusted by moving the lens unit 311. For the same image, when the image is in focus, a focus value becomes high. In contrast, when the image is out of focus, a focus value becomes low.

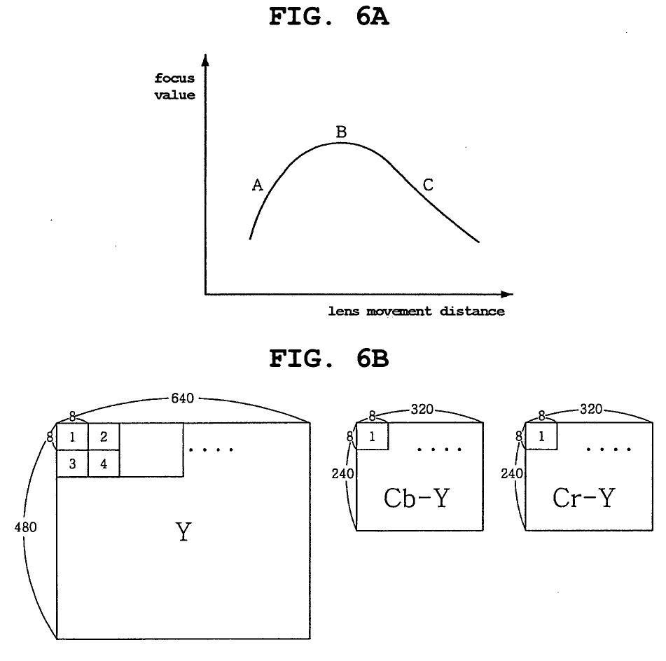

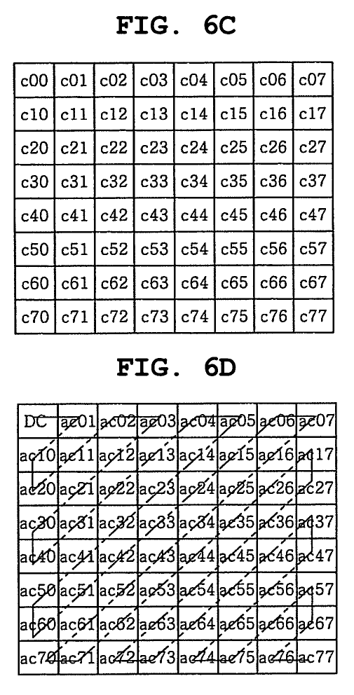

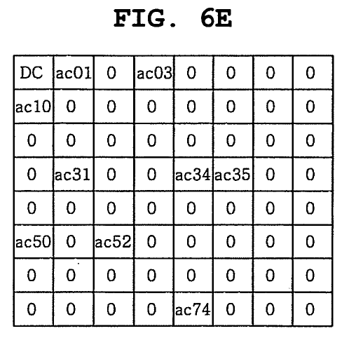

Referring to FIG. 6A, when the same image is input to a camera, a low focus value is generated, such as in regions “A” or “C,” when the image is in focus, and a high focus value is generated, such as in a region “B,” when the image is out of focus. Meanwhile, for a complex image, the focus values in the region “B” are higher, and for a simple image, the focus values in the region “B” are lower. Generally, a camera is focused on the center of an image, and a window is placed on the basis of the center.

To find the maximal focus value of a screen, the lens unit 311 is moved by operating the actuator 315 using the actuator driver 314. The location where the focus value is maximal, as shown in FIG. 6A, must be found by moving the lens unit 311.

The camera module determines whether to move the lens unit 311 forward or backward and controls the actuator driver 314 by executing an algorithm to find the maximal focus value in the CPU 420.

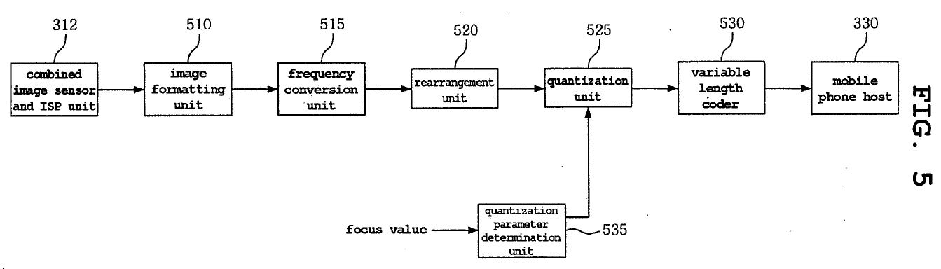

Meanwhile, the compression module 320 compresses image data received from the combined image sensor and ISP unit 312 and outputs compressed image data. The internal block diagram of the compression module 320 is shown in FIG. 5. The compression module 320 includes an image formatting unit 510, a frequency conversion unit 515, a rearrangement unit 520, a quantization unit 525 and a variable length coder 530.

The image formatting unit 510 receives the output of the image signal processor, and outputs pixel_data in YCbCr 4:2:2 or YCbCr 4:2:0 form, which has CCIR656 or CCIR601 format, and the vertical and horizontal signals of one frame so that appropriate input is provided for later image processing.

For this purpose, the image formatting unit 510 performs color coordinate conversion, that is, converts RGB format data into YCbCr or YUV format. For example, CCIR-601 YCbCr color space conversion formulas are expressed as follows:
Y=(77R+150G+29B)/256 Range: 16˜235
Cb=(−44R−87G+131B)/256+128 Range: 16˜240
Cr=(131R−110G−21B)/256+128 Range: 16˜240

The image formatting unit 510 performs a chrominance format conversion on the YCbCr format data converted as described above, so that YCbCr 4:4:4 format data are converted into YCbCr 4:2:2 format data or YCbCr 4:2:2 format data and are then output. FIG. 6B shows YCbCr format data that are output when the number of pixels of one frame is 640×480.

In the 4:2:0 format data of FIG. 6B, a Y signal is output in the form of 640×480 pixels in the order of assigned reference numbers, a Cb signal is output in the form of 320×240 pixels that are halved in each dimension compared to the Y signal, and a Cr signal is also output in the form of 320×240 pixels that are halved in each dimension compared to the Y signal.

The chrominance format conversion of the image formatting unit 510 is based on the low spatial sensitivity of eyes to color. Studies have proven that color component sub-sampling using four factors in horizontal and vertical directions is appropriate. Accordingly, an image signal can be represented by four luminance components and two chrominance components.

Furthermore, the image formatting unit 510 contains frame memory, and transmits the data of a two-dimensional 8×8 block while varying memory addresses for Y/Cb/Cr pixel data that are input in a horizontal direction. Specifically, the image formatting unit 410 transmits a composite YCbCr by a macro block unit that is defined by a plurality of 8×8 blocks.

That is, the image formatting unit 510 blocks an input image signal to correspond to a unit region (a block) that is composed of a predetermined number of pixels, and outputs the blocked image signal. In this case, the block is a region of a predetermined size in a picture, which is a unit for a process of encoding image signals, and is composed of a predetermined number of pixels.

A conversion example of the image formatting unit 510 is shown in FIG. 6C, in which an input image signal is blocked into a plurality of 8×8 blocks. In this case, 8 bits may be used to represent the value of each 8×8 block.

Then, the frequency conversion unit 515 frequency-transforms the blocked image signal using Discrete Cosine Transform (DCT) and then outputs a frequency component that corresponds to each block.

DCT used in the above case divides pixel values irregularly distributed through a screen into various frequency components ranging from a low frequency component to a high frequency component by transforming the pixel values, and concentrates the energy of an image on the low frequency component.

DCT, which has been established as a core technique of various international standards, such as H.261, JPEG and MPEG, is performed on an 8×8 size block basis. The basic scheme of DCT is based on the concept of space, and DCT is a core technique of H.261, JPEG and MPEG that are multimedia-related international standards.

The basic scheme of the DCT divides data having high spatial correlation into a plurality of frequency components ranging from a low frequency component to a high frequency component using orthogonal transform, and differently quantizes individual frequency components.

DCT moves the energy of the blocks so that most of the energy is concentrated on the low frequency components in a frequency domain, thus increasing a compression effect. FIG. 6D shows the arrangement of DCT coefficients in the case of an 8×8 block in which DC designates a low frequency component, and ac01˜ac77 designate high frequency components.

The rearrangement unit 520 rearranges input data from low frequency components to high frequency components and outputs rearranged data. That is, DCT coefficients are rearranged in the order of ac01, ac10, ac20, . . . , ac77a by performing zigzag scan along the dotted line of FIG. 6D.

Thereafter, the rearranged data are input to the quantization unit 525 and are quantized therein. The quantization parameter varies according to individual blocks with respect to individual DCT coefficients.

In this case, the quantization parameter is a parameter that represents the size of a quantization step, and the quantization step is almost proportional to the quantization parameter. That is, when the quantization parameter is large, the quantization step becomes rough, so that the absolute value of the quantization component becomes small. Accordingly, since the zero run (the length of components having a zero value that are continuously arranged) of the quantization component is lengthened, the absolute value of a level value decreases.

In contrast, when the quantization parameter is small, the quantization step becomes fine and, thus, the absolute value of a quantization component becomes large. Accordingly, the zero run is shortened, so that the absolute value of the level value becomes large.

Generally, high frequency components represent the fine portions of an image due to the perception capability of humans. Since the loss of some high frequency components has hardly any effect on image quality to the extent that human eyes cannot sense it, low frequency components, containing much information, are finely quantized with a quantization size decreased, but high frequency components are quantized with the quantization size increased, so that compression efficiency can be maximized with only slight loss of image quality.

The present invention receives the quantization parameter from a quantization parameter determination unit 535 and uses it. The quantization parameter determination unit 535 receives a focus value, and determines the quantization parameter depending on the input focus value.

The method of determining the quantization parameter by the quantization parameter determination unit 535 varies with the focus value. Since a large focus value means that an image to be quantized is complex, fine quantization is performed with the decreased quantization parameter. In contrast, since a small focus value means that an image to be quantized is simple, rough quantization is performed with the increased quantization parameter.

The data quantized in the quantization unit 525 as described above, possessing much data that are converted into “0”, are input to the variable length coder 539 and are then converted into compressed code therein. For example, FIG. 6E shows quantized DCT coefficients, including DC, ac01, ac10, 0, 0, 0, ac03, 0, 0, ac31, 0, ac50, 0, 0, 0, 0, 0, 0, 0, 0, 0, 0, 0, 0, 0, 0, ac52, . . . , that is, DC, ac01, ac10, three 0s, ac03, two 0s, ac31 and one 0, ac50s, fourteen 0s, . . . ,

The variable length coder 530 allocates code to the quantization components using numerical values representing the sizes of the quantization components and a code table representing correspondence to the code, and converts the quantization components of individual blocks into a coded stream.

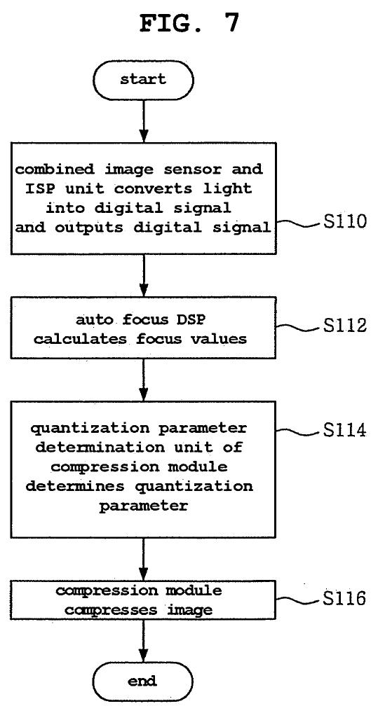

FIG. 7 is a flowchart illustrating an image compression method in accordance with an embodiment of the present invention.

The combined image sensor and ISP unit 312 converts an optical signal into an electrical analogue signal, processes the analogue signal to eliminate high frequency noise and adjust amplitude, converts the analogue signal into a digital signal, and outputs the digital signal at step S110.

Thereafter, the ODM 410 of the auto focus DSP 313 extracts edge components from an image, and then obtains the focus value by accumulating values within a window region at step S112.

Thereafter, the quantization parameter determination unit 535 receives the focus value, determines the quantization parameter according to the input focus value, and outputs the quantization parameter at step S114.

In this case, the method of determining the quantization parameter by the quantization parameter determination unit 535 varies with the focus value, as described above. Since a large focus value means that an image to be quantized is complex, fine quantization is performed with the decreased quantization parameter. In contrast, since a small focus value means that an image to be quantized is simple, rough quantization is performed with the increased quantization parameter.

Thereafter, the compression module 320 compresses and outputs image data that are input from the combined image sensor and ISP unit 312. In this case, the quantization unit 525 of the compression module 320 performs the image compression while performing the quantization using the value that is transmitted from the quantization parameter determination unit 535 as the quantization parameter.

As described above, in accordance with the present invention, the image compression apparatus includes the camera and compression modules in the auto focus system, and, therefore, can transmit compressed data to an image apparatus, such as a mobile phone. Furthermore, when image compression is performed, the image compression apparatus determines whether an image to be compressed is complex or simple using image information in an image processing apparatus that is used to perform automatic focus compression, thus differently performing compression on complex and simple images.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An image compression apparatus, comprising:
an image sensor unit for converting an optical signal into an electrical signal;
an Image Signal Processor (ISP) unit for receiving the electrical signal from the image sensor unit and outputting digitized image data;
an auto focus Digital Signal Processor (DSP) for receiving the image data from the ISP, extracting edge components from the image data, calculating a focus value by integrating edge component values of a window set region, and calculating a maximal focus value while driving a focus lens of a lens unit; and
a compression module for receiving the maximal focus value from the auto focus DSP, and performing image compression while quantizing the image data, which are input from the ISP unit, using a quantization parameter determined according to the received maximal focus value.

2. The image compression apparatus as set forth in claim 1, wherein the auto focus DSP comprises:
an optical detection module for receiving the image data from the ISP unit, extracting the edge components from the image data, and calculating the focus value by integrating the edge component values of the window set region; and
a central processing unit for receiving the focus value from the optical detection module, calculating the maximal focus value while driving the focus lens of the lens unit, and performing automatic focus adjustment.

3. The image compression apparatus as set forth in claim 2, wherein the optical detection module comprises:
a high bandpass filter for receiving the image data from the ISP unit and extracting the edge components of the window set region;
an integrator for receiving the extracted edge components from the high bandpass filter, integrating the extracted edge components of the window set region and outputting the integration result; and
a window setting unit for transmitting start and end addresses of the window set region that are set on the integrator.

4. The image compression apparatus as set forth in claim 1, wherein the compression module comprises:
an image formatting unit having frame memory, the image formatting unit classifying the input image data according to frame when the image data are input, blocking each classified frame into a plurality of blocks having a predetermined size, and outputting the blocked data;
a discrete cosine transform unit for performing a discrete cosine transform on the blocked image data received from the image formatting unit, and outputting discrete cosine transform coefficients;
a rearrangement unit for rearranging the discrete cosine transform coefficients, which are received from the discrete cosine transform unit, from a low frequency component to a high frequency component, and outputting the rearranged discrete cosine transform coefficients;
a quantization unit for performing quantization on the rearranged discrete cosine transform coefficients, which are input from the rearrangement unit, while applying quantization values to the rearranged discrete cosine transform coefficients according to the focus values that are received from the auto focus DSP; and
a variable length coder for performing variable length coding on the quantized discrete cosine transform coefficients using the quantization unit, and outputting the variable length-coded quantized discrete cosine transform coefficients.

5. An image compression method, comprising the steps of;
converting, by a combined image sensor and an ISP unit, an optical signal into an electrical signal and then outputting digitized image data;
receiving, by an auto focus DSP, the image data from the ISP unit, extracting edge components, and calculating focus values by integrating edge component values of a window set region;
calculating, by the auto focus DSP, a maximal focus value while driving a focus lens of a lens unit; and
receiving, by a compression module, the maximal focus value from the auto focus DSP, and performing image compression while quantizing the image data, which is input from the ISP, using a quantization parameter determined according to the received maximal focus value.

6. The image compression method as set forth in claim 5, wherein the receiving step by the auto focus DSP comprises the steps of:
receiving, by an optical detection module of the auto focus DSP, the image data from the combined image sensor and ISP unit, and extracting the edge components of the window set region; and
calculating, by the optical detection module, the focus values by integrating the edge component values of the window set region.

7. The image compression method as set forth in claim 5, wherein the receiving step by the compression module comprises the steps of:
classifying, by an image formatting unit of the compression module, provided with a frame memory, the input image data according to a frame when the image data are input, blocking each classified frame into a plurality of blocks having a predetermined size, and outputting the blocked data;
performing, by a discrete cosine transform unit, a discrete cosine transform on the blocked image data received from the image formatting unit, and outputting discrete cosine transform coefficients;
rearranging, by a rearrangement unit, the discrete cosine transform coefficients, which are received from the discrete cosine transform unit, from a low frequency component to a high frequency component, and outputting the rearranged discrete cosine transform coefficients;
performing, by a quantization unit, quantization on the rearranged discrete cosine transform coefficients, which are input from the rearrangement unit, while applying quantization values to the rearranged discrete cosine transform coefficients according to the focus values that are received from the auto focus DSP; and
performing, by a variable length coder, variable length coding on the quantized discrete cosine transform coefficients using the quantization unit, and outputting the variable length-coded quantized discrete cosine transform coefficients.
